(19) United States
(12) Patent Application Publication
(10) Pub. No.: US 2017/0228756 A1
(43) Pub. Date: Aug. 10, 2017

(54) MAPPING RETAIL OFFERS

(71) Applicant: Target Brands, Inc., Minneapolis, MN (US)

(72) Inventors: Amber M. Reimer, Minneapolis, MN (US); Michael Kenneth Link, Golden Valley, MN (US); Sushant Kumar, Karnataka (IN); Ananth Ranganath, Minnetonka, MN (US)

(21) Appl. No.: 15/019,528

(22) Filed: Feb. 9, 2016

(51) Int. Cl. G06Q 30/02; G06Q 90/00

(52) U.S. Cl. CPC G06Q 30/0224; G06Q 90/20

(57) ABSTRACT

A computer-implemented method includes providing at least one user interface to allow a user to select an offer through a computer network, the offer being applicable to more than one product. A request to display a map of a retail store is received and in response the map of the retail store is displayed. The displayed map includes a plurality of symbols for a single offer, each symbol showing the location of a different product in the retail store that the offer is applicable to.

### BACKGROUND

Consumers are able to select coupons and other offers using the Internet and then redeem those offers at a physical store. For example, offers selected by the consumer over the Internet may be represented by one or more bar codes that can be displayed on the user's mobile device when the user is paying for their purchases. Such bar codes can be scanned at the register to convey the offer information to the register.

The discussion above is merely provided for general background information and is not intended to be used as an aid in determining the scope of the claimed subject matter. The claimed subject matter is not limited to implementations that solve any or all disadvantages noted in the background.

### SUMMARY

A computer-implemented method includes providing at least one user interface to allow a user to select an offer through a computer network, the offer being applicable to more than one product. A request to display a map of a retail store is received and in response the map of the retail store is displayed. The displayed map includes a plurality of symbols for a single offer, each symbol showing the location of a different product in the retail store that the offer is applicable to.

In a further embodiment, a mobile device includes a processor showing a user interface that includes a map control on a display of the mobile device. In response to receiving a selection of the map control, the processor requests a map of a retail store from a server, wherein the map includes markers at locations of products associated with offers currently selected by a user. The markers comprise a plurality of markers for one offer where each of the plurality of markers is for a different product. The processor then produces a second user interface showing at least part of the map received from the server.

In a still further embodiment, a method includes displaying a user interface showing a map with a plurality of markers, each marker representing a different product associated with a single offer. A selection of one of the markers is received and in response, the user interface is altered to show details of the single offer.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of a system in accordance with one embodiment.

FIG. 2 is a flow diagram of a method in accordance with one embodiment.

FIG. 3 is an example of a user interface for viewing available offers.

FIG. 4 is an example of a user interface for selecting an offer.

FIG. 5 is an example of a user interface showing selected offers.

FIG. 6 is an example of a user interface showing an offer map.

FIG. 7 is an example of the user interface of FIG. 6 with a marker selected.

FIG. 8 is an example of the user interface of FIG. 6 with another marker for the same offer selected.

FIG. 9 is an example of a user interface for selecting an additional offer.

FIG. 10 is an example of a user interface showing selected offers after selecting the additional offer.

FIG. 11 is an example of the user interface of FIG. 6 with a marker for the additional offer.

FIG. 12 is a block diagram of a mobile device that can be used in the various embodiments.

### DETAILED DESCRIPTION

Although the Internet has made it easier to search for and select retail offers, it has also created a problem for customers when they visit a physical store to redeem the selected offers. In particular, when a customer visits a store, they must consult their mobile device to see what offers they have selected. However, such mobile devices have limited screen sizes so only a limited number of the offers can be viewed at one time and only a limited amount of information can be displayed for each offer. In particular, for offers that can be applied to a large number of different products, the limited display size makes it extremely difficult to show all of the products that the offer can be redeemed against. Thus, the existing technology is insufficient to convey to consumers information they need to make full use of their selected offers.

In the embodiments described below, offer maps are constructed for a store that show the locations of products that selected offers can be redeemed against. In particular, when a customer selects a map control, the offers selected by the customer are retrieved and for each offer, a list of products that are associated with the offer is retrieved. The location of each product within a store is then determined and a user interface is generated that shows a map of the store with markers indicating the positions of the products associated with the offers. Since multiple products can be associated with a single offer, there can be multiple markers for a single offer. In accordance with some embodiments, each marker is selectable such that when a marker is selected, details of the offer and the particular product associated with the marker are displayed.

In the discussion below, a “product” is an item for sale that receives a separate designation in a retailer's database. There can be multiple units of a product for sale at the same time. However, each unit of the product shares a common designation in the retailer's database. For example, a 12 oz. container of tomato soup from manufacturer A is a product while each can of that soup represents one unit of that product. Further, references below to a location of a product can include locations that have one or more units of the product.

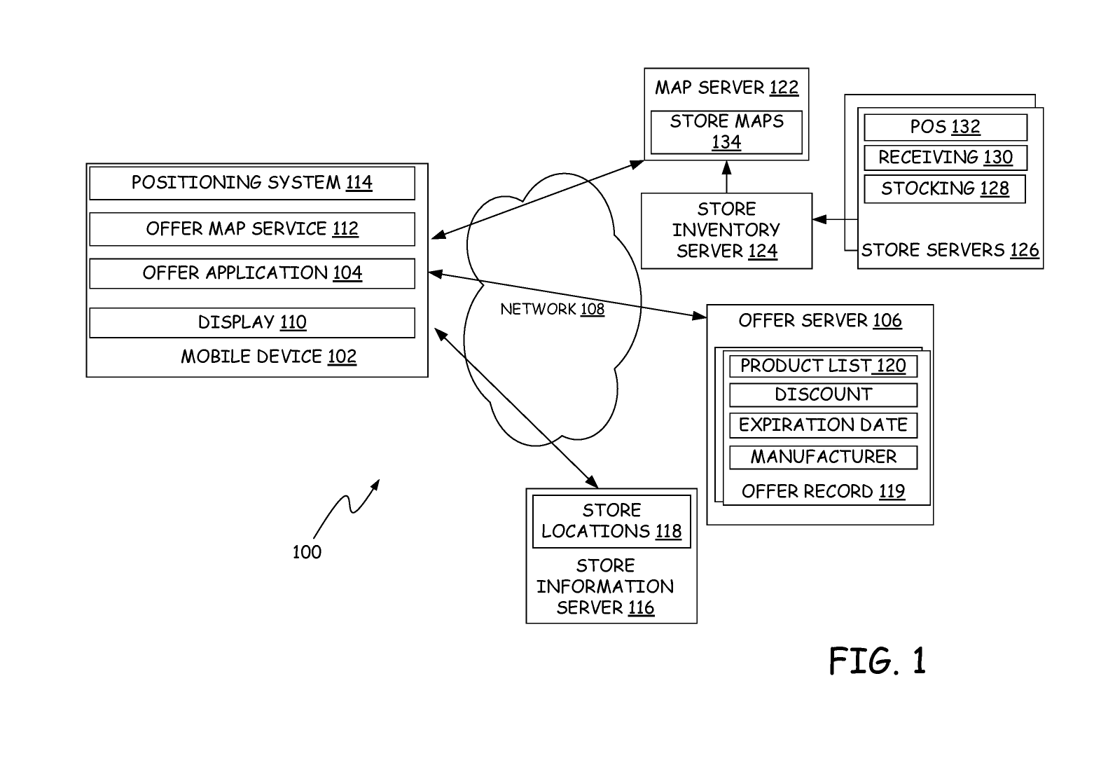

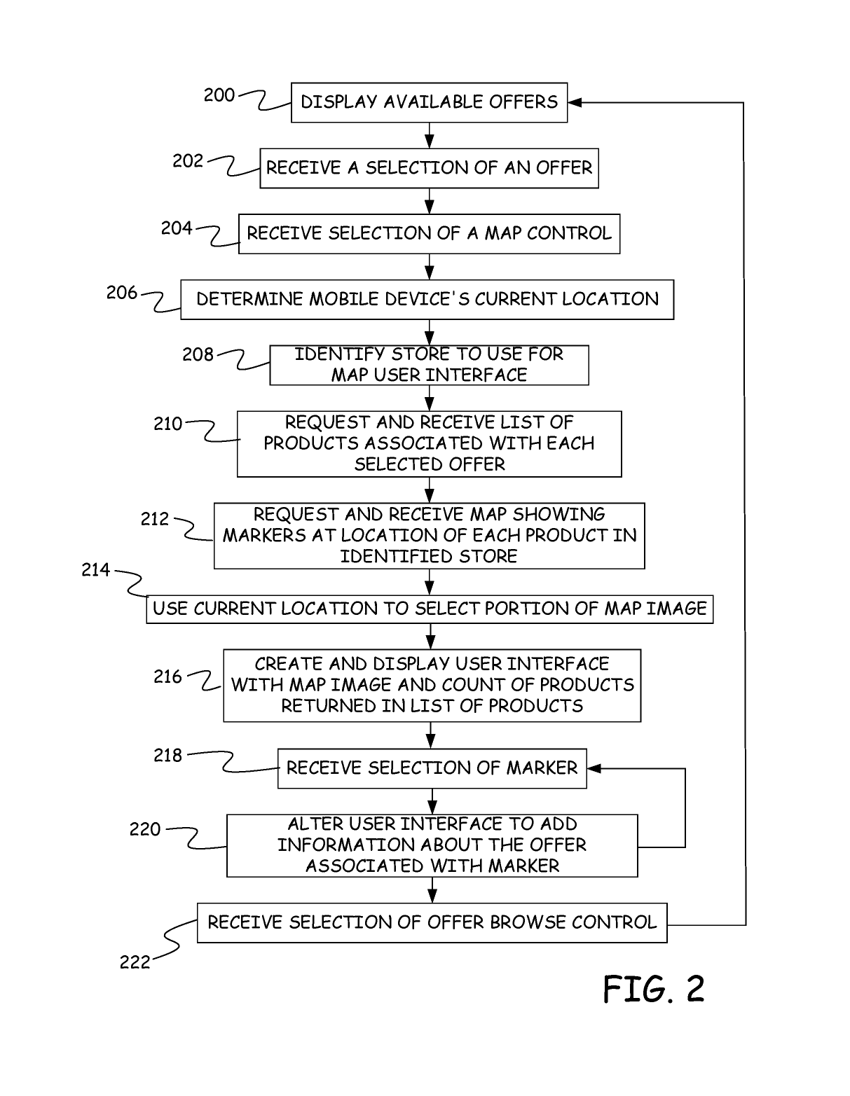

FIG. 1 provides a block diagram of a system 100 and FIG. 2 is a flow diagram of a method in accordance with one embodiment for displaying a user interface that shows a map of selected offers. System 100 includes a mobile device 102 that is used by a customer to select retail offers, to locate products associated with those offers in a retail store, and to redeem the offers at a point of sale register at the retail store. Mobile device 102 includes an offer application 104, which accesses an offer server 106 through a network 108 that includes the Internet.

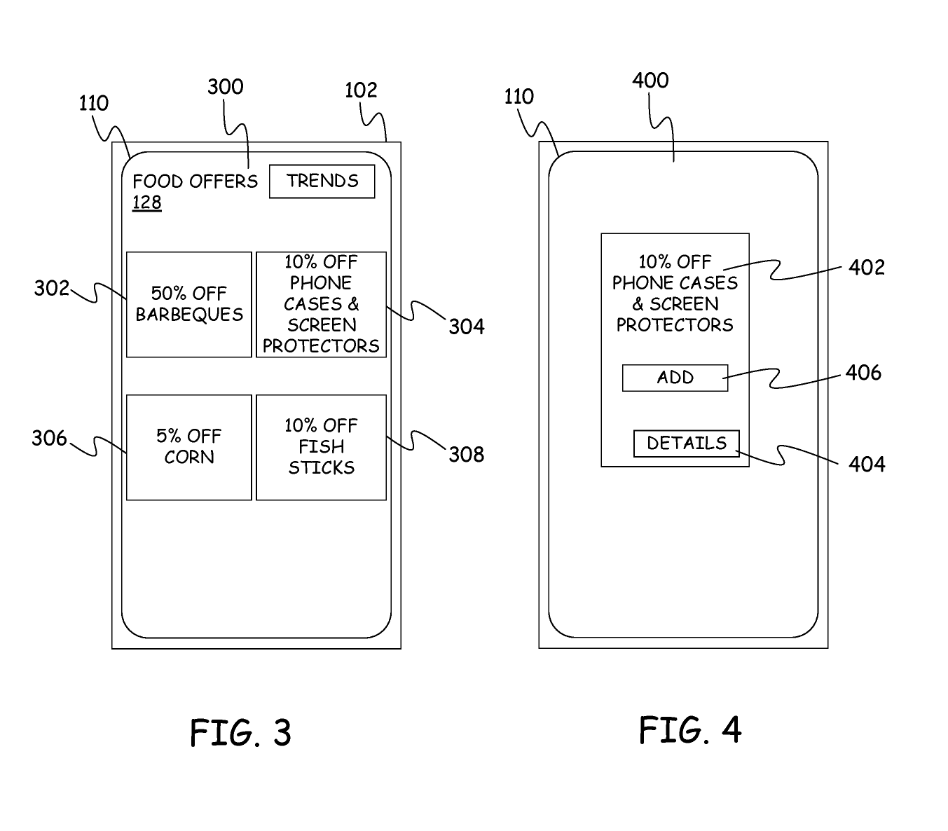

Offer application 104 requests available offers from offer server 106 and displays available offers on a display 110 of mobile device 102 at step 200 of FIG. 2. FIG. 3 provides an example user interface 300 on display 110 showing a set of available offers represented by offer icons 302, 304, 306 and 308.

At step 202, offer application 104 receives a selection of an offer. In accordance with one embodiment, an offer is selected by first selecting one of the available offer icons, such as one of icons 302, 304, 306, or 308. In response, a selection confirmation user interface such as user interface 400 of FIG. 4 is displayed. User interface 400 includes details 402 about the offer, a further details control 404, which when activated causes a user interface with further details about the offer to be shown, and an “add” control 406, which when activated causes the offer to be added to the customer's list of selected offers. In accordance with some embodiments, the customer is only allowed to select a limited number of offers.

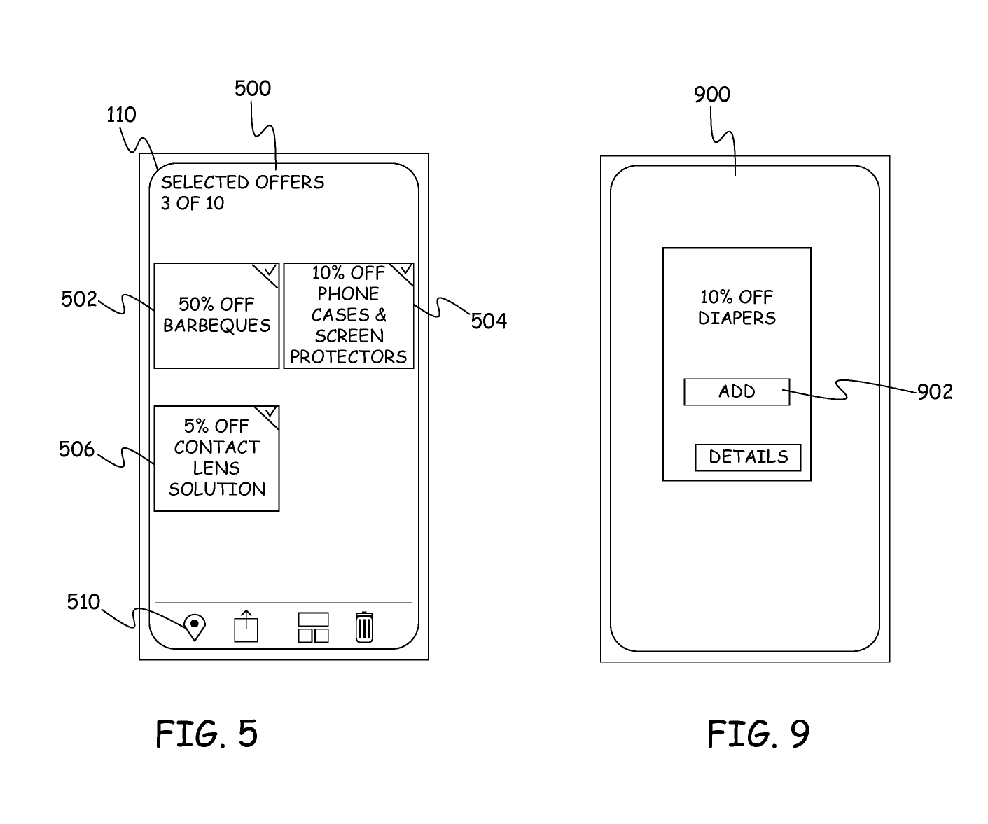

After an offer is selected, the customer is provided with a user interface 500 of FIG. 5 showing the offers that the user has selected as selected-offer icons such as icons 502, 504 and 506. Each selected-offer icon includes a check mark in the upper-right corner of the icon to indicate that the offer has been selected. User interface 500 includes a “map” control 510. At step 204 of FIG. 2, the customer selects “map” control 510 and offer application 104 receives the selection. In response, offer application 104 calls an offer map service 112 on mobile device 102. At step 206, offer map service 112 determines the location of mobile device 102 using a positioning system 114. Positioning system 114 can include one or more of a global positioning system, a cellular tower positioning system, and an indoor positioning system such as a visible light communication system that provides position information through light fixtures in the store.

At step 208, offer map service 112 identifies a store to use for a map user interface. In accordance with one embodiment, the store is identified using the location of mobile device 102 determined in step 206. In particular, offer map service 112 contacts a store information server 116, which holds store locations 118, to request the closest store to mobile device 102. In accordance with some embodiments, the closest store to the mobile device is identified as the store to use for the map user interface. In accordance with other embodiments, offer map service 112 also requests the distance between the mobile device and the closest store. If the distance exceeds a threshold, offer map service 112 will not use the closest store but instead will use a preferred store that the user has previously selected. Typically, the preferred store represents the store where the user most often shops.

At step 210, offer map service 112 requests a list of products associated with each selected offer from offer server 106. In response to the request, offer server 106 retrieves an offer record 119 for each selected offer, where each offer record 119 includes a list 120 of the products that the offer can be redeemed against. Offer server 106 then returns each product list 120 to offer map service 112, which receives and stores the product lists on mobile device 102.

At step 212, offer map service 112 requests a store map from a map server 122. As part of the request, offer map service 112 provides an identifier for the store selected in step 208 and identifiers for the products in the product lists received at step 210. Map server 122 uses the store identifier and the product identifiers to request the location of each of the products in the identified store from a store inventory server 124. In accordance with one embodiment, store inventory server 124 receives real-time updates of products that are currently in each store from respective store servers 126. The real-time updates include updates from stocking applications 128 on store servers 126 that indicate when a product is assigned to a location in the store; updates from receiving application 130 that indicate when units of the product are received at the store; and updates from Point Of Sale (POS) applications 132 that indicate when units of the product are sold. Using the information about the number of units received at the store and the number of units sold, store inventory server 124 can keep track of whether a product should be available at a particular store. Thus, store inventory server 124 contains information about what products are available at each store and the location of those products in the respective stores. Using this information, store inventory server 124 returns the location of each product in the list of products that is currently in the identified store. If a product in the list is not currently available in the store, store inventory server 124 does not return a location for that product.

Map server 122 uses the product locations returned by store inventory server 124 to place markers in a store map 134 of the selected store. Each marker is provided with associated metadata that indicates the offer associated with the marker and the product associated with the marker. If one of the products in the list of products is not available at the store, map server 122 will not include a marker for that product. Thus, it is possible for some products that are associated with an offer to not be shown on the map. Once the map has been augmented, it is returned with the markers and metadata to offer map service 112.

At step 214, offer map service 112 uses the current location of mobile device 102 to select a portion of the map image returned by map server 122. For example, if mobile device 102 is currently located outside of the store, the entire map image is selected. On the other hand, if mobile device 102 is positioned within the store, the location of mobile device 102 within the store is used to select the portion of the map image. In particular, a portion of the map image representing the position where mobile device 102 is located in the store is selected.

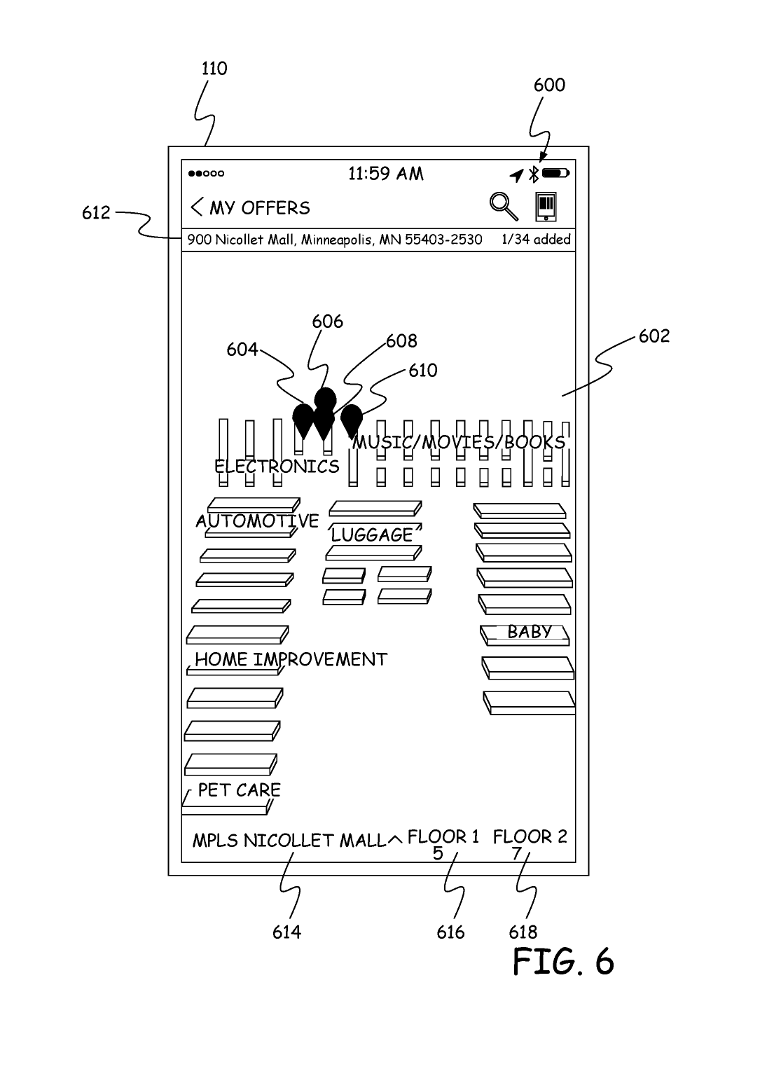

At step 216, a user interface is created and displayed on display 110 using the selected portion of the map image. The user interface includes the selected portion of the map image and the markers within the selected portion as well as a count of the number of distinct products that are associated with the selected offers and are found in the identified store. FIG. 6 provides an example of a user interface 600 that shows a portion of a map image 602 with product location markers or symbols 604, 606, 608 and 610. User interface 600 also includes product counts 616 and 618, which provide the number of products on different respective floors of the store that the selected offers can be redeemed against. User interface 600 also includes store identifier 612 and store selector 614, which provide descriptors of the store shown in map image 602. Store selector 614 can be selected to open a menu to change the store shown in the map. When a new store is selected, offer map service 112 requests a new map from map server 122 for the newly selected store and then displays a portion of the newly selected store using steps 212, 214 and 216 described above.

Product location markers 604, 606, 608 and 610 each represent different products that a single offer can be redeemed against. Thus, for one offer, map user interface 600 can show a separate marker for a plurality of different products that are associated with the offer. For example, an offer for 10% of phone cases and screen protectors, can have separate markers for each of a plurality of phone cases and separate markers for each of a plurality of screen protectors. Thus, in one user interface, a user is able to see the locations of a plurality of products associated with an offer and not just the locations of a single product associated with an offer. As a result, the user interface overcomes the technological limitations of the mobile device's display to provide the customer with more information about the multiple products that an offer can be redeemed against.

At step 218, offer map service 112 receives input from the user indicating that the user has selected one of the product location markers such as product location marker 604 of FIG. 6. In response, at step 220, offer map service 112 alters the user interface to add information about the offer and the product associated with the marker. In accordance with one embodiment, this information is taken from the metadata associated with the selected maker that is returned by map server 122.

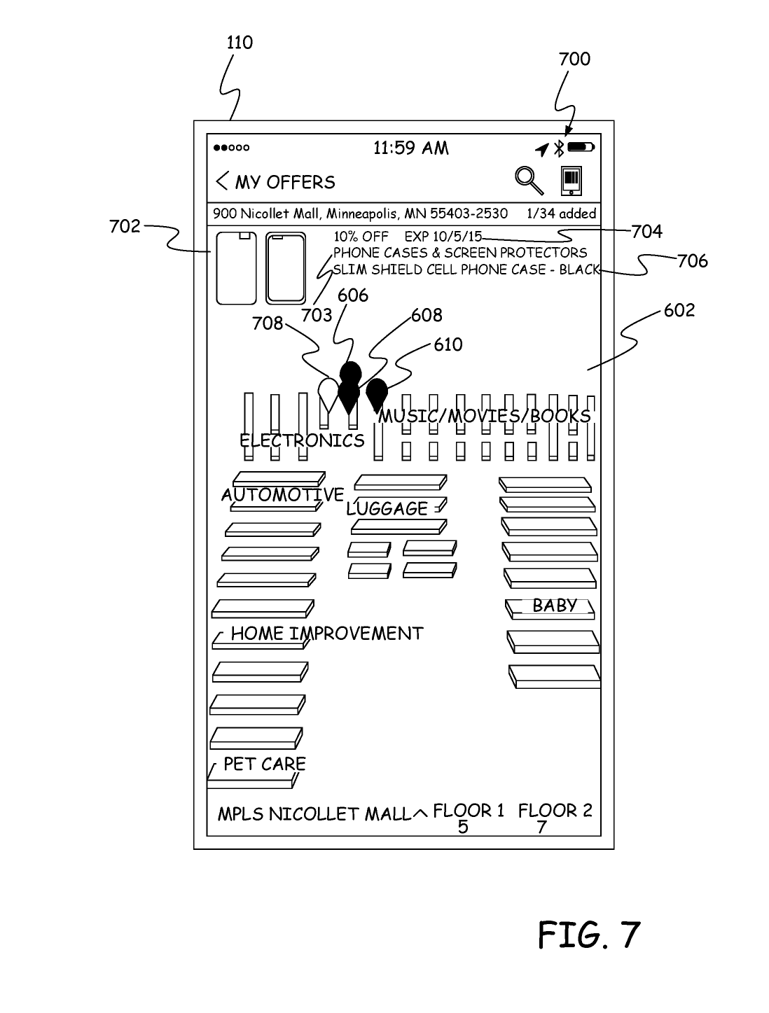

FIG. 7 provides an example of a user interface 700, which includes alterations to user interface 600 made in response to a user's selection of marker 604. The alterations include changing the color of maker 604 to form marker 708 and thereby indicate which marker has been selected. In addition, offer information 702 has been added that includes offer description 703 consisting of “10% off” and “Phone Cases & Screen Protectors”, and expiration date 704. Further, product identifying information 706 has been added that identifies the product that marker 708 represents. Thus, when one of the selectable markers is selected, the user interface is altered to include information about the offer and information about the product represented by the offer.

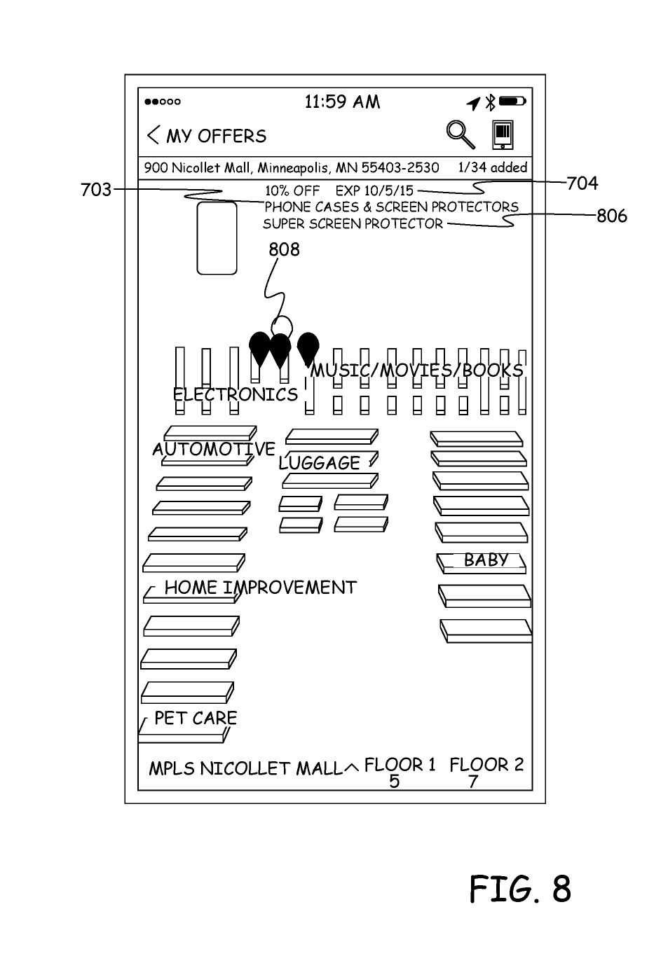

FIG. 8 provides an example of a user interface 800, which includes alterations to user interface 600 made in response to a user's selection of marker 606. The alterations include changing the color of maker 606 to form marker 808 and thereby indicate which marker has been selected. In addition, offer information 802 has been added that includes offer description 703 consisting of “10% off” and “Phone Cases & Screen Protectors”, and expiration date 704. Further, product identifying information 806 has been added that identifies the product that marker 808 represents. As can be seen from FIGS. 7 and 8, offer description 703 is the same for both marker 708 and 808 because both markers refer to the same selected offer. However, product identifying information 706 is different from product identifying information 806 because markers 708 and 808 represent different products.

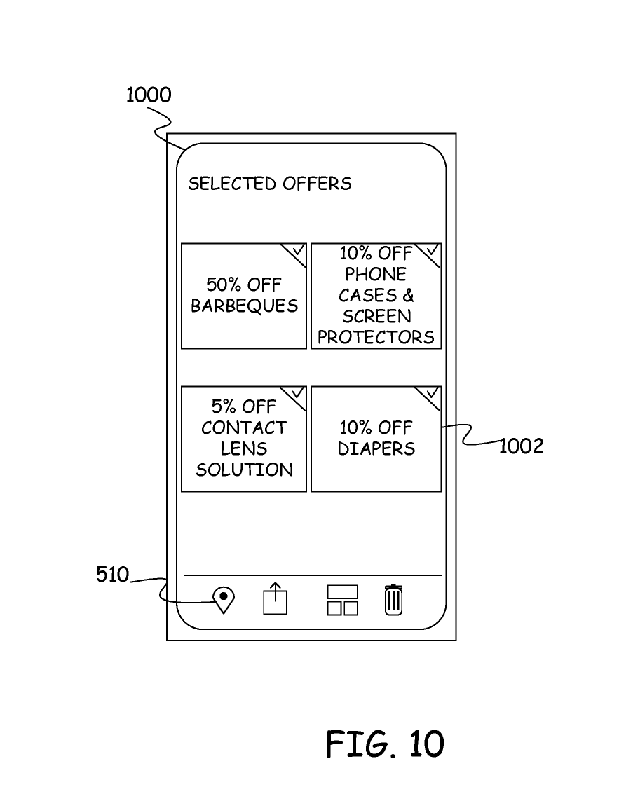

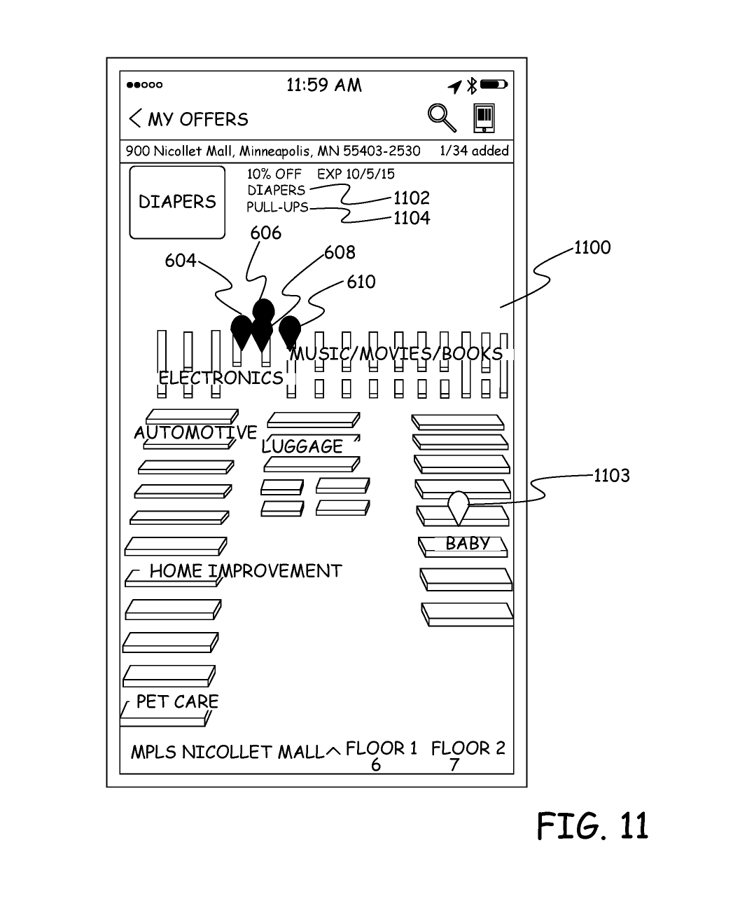

While an offer map user interface is displayed, a user can request that offer application 104 display a menu by, for example, making a swiping gesture on display 110. Once the menu is displayed, the user can select a “browse offers” control at step 222. In response, offer application 104 returns to step 200 and displays an available offer user interface such as user interface 300 of FIG. 3. The user can then select another offer at step 202 using an offer confirmation user interface such as offer confirmation user interface 900 of FIG. 9. When the user selects “add” control 902 of user interface 900, the associated offer is added to the selected offers as shown in user interface 1000 of FIG. 10, where icon 1002 has been added for the newly selected offer. When the user once again selects map control 510 at step 204, steps 206-220 are repeated and an offer map user interface such as user interface 1100 of FIG. 11 is displayed. In FIG. 11, a new product location marker 1103 has been added to the user interface. In addition, the user has selected marker 1103 causing offer information 1102 and product information 1104 to be shown on user interface 1100.

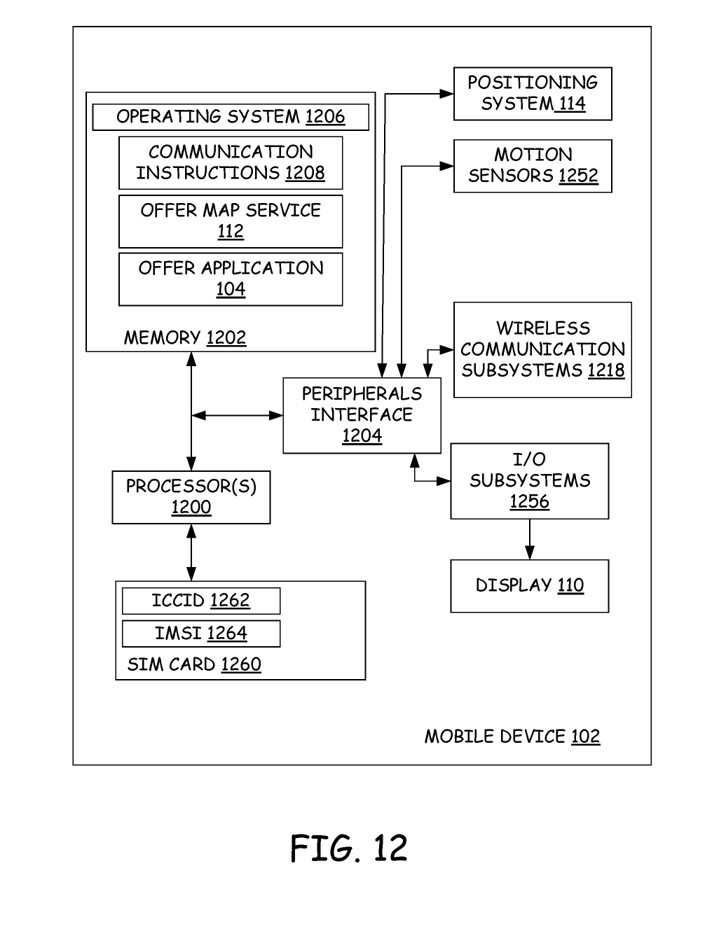

FIG. 12 illustrates a block diagram of mobile device 102 Mobile device 102 includes one or more processors 1200, such as a central processing unit or image processors, and a memory 1202. Processor(s) 1200 and memory 1202 are connected by one or more signal lines or buses. Memory 1202 can take the form of any processor-readable medium including a disk or solid-state memory, for example. Memory 1202 includes an operating system 1206 that includes instructions for handling basic system services and performing hardware-dependent tasks. In some implementations, operating system 1206 can be a kernel. Memory 1202 also includes various instructions representing applications that can be executed by processor(s) 1200 including communication instructions 1208 that allow processor 1200 to communicate through peripherals interface 1204 and wireless communication subsystems 1218 to a wireless cellular telephony network and/or a wireless packet switched network and/or a local area network using a wireless communication standard. Memory 1202 also contains offer application 104 and offer map service 112.

Peripherals interface 1204 provides access between processor(s) 1200 and one or more of positioning system 114, motion sensors 1252, and input/output subsystems 1256. Positioning system 114 receives external signals, such as signals from Global Positioning Satellites, and converts the signals into position information, such as longitudinal and latitude information, describing the location of mobile device 102. The position of mobile device 102 may also be determined using other positioning systems such as Wi-Fi access points, television signals, cellular grids, and information from light sources in the interior of a building. Motion sensors 1252 can take the form of one or more accelerometers, a magnetic compass, a gravity sensor and/or a gyroscope. Motion sensors 1252 provide signals indicative of movement or orientation of mobile device 202. I/O subsystems 1256 control input and output for mobile device 102. I/O subsystems 1256 can include touchscreen display 110, which can detect contact and movement or break thereof using any of a plurality of touch sensitivity technologies including, but not limited to capacitive, resistive, infrared and surface acoustic wave technologies as well as other proximity sensor arrays or other elements for determining one or more points of contact with display 110. Other inputs can also be provided such as one or more buttons, rocker switches, thumb wheel, infrared port, USB port and/or pointer device such as a stylus.

Mobile device 102 can also include a subscriber identity module, which in many embodiments takes the form of a SIM card 1260. SIM card 1260 stores an ICCID 1262 and an IMSI 1264. ICCID 1262 is the Integrated Circuit Card Identifier, which uniquely identifies this card on all networks. IMSI 1264 is the international mobile subscriber identity, which identifies the SIM card on an individual cellular network. When communicating through wireless communication subsystems 1218, processor(s) 1200 can use identifiers 1262 and/or 1264 to uniquely identify mobile device 102 during communications. In accordance with many embodiments, SIM card 1260 is removable from mobile device 202 and may be inserted in other devices.

Although elements have been shown or described as separate embodiments above, portions of each embodiment may be combined with all or part of other embodiments described above.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms for implementing the claims.

What is claimed is:

1. A computer-implemented method comprising:
providing at least one user interface to allow a user to select an offer through a computer network, the offer being applicable to more than one product;
receiving a request to display a map of a retail store;
displaying the map of the retail store, the displayed map including a plurality of symbols for the offer, each symbol showing the location of a different product in the retail store that the offer is applicable to.

2. The computer-implemented method of claim 1 wherein the at least one user interface allows the user to select multiple offers through the computer network and wherein displaying the map of the retail store further comprises displaying at least one additional symbol showing the location of an additional product that a second offer is applicable to.

3. The computer-implemented method of claim 2 wherein displaying the map further comprises displaying a count of the number of products that selected offers are applicable to.

4. The computer-implemented method of claim 1 wherein each symbol is selectable and wherein when a symbol is selected, details of the offer associated with the symbol are displayed while continuing to display the map.

5. The computer-implemented method of claim 1 wherein displaying the map of the retail store comprises retrieving a list of products associated with the offer, identifying a store from a plurality of possible stores, requesting the location in the identified store of each product in the list of products, receiving locations for products, and setting the position of the symbols in the map based on the received locations.

6. The computer-implemented method of claim 5 wherein the steps of retrieving a list of products, requesting locations in the identified store of each product, receiving locations for products, and setting the position of symbols is repeated for each of a plurality of selected offers.

7. The computer-implemented method of claim 6 wherein for at least one offer, no locations for products are received and no position for a symbol associated with the offer is set.

8. A mobile device comprising:
a processor showing a user interface that includes a map control on a display of the mobile device;
in response to receiving a selection of the map control, the processor requesting a map of a retail store from a server over a network, wherein the map includes markers at locations of products associated with offers currently selected by a user, the markers comprising a plurality of markers for one offer where each of the plurality of markers is for a different product; and
the processor producing a second user interface showing at least part of the map received from the server.

9. The mobile device of claim 8 wherein the markers further comprise markers for a plurality of offers.

10. The mobile device of claim 9 wherein the second user interface comprises a selectable control for selecting a different retail store such that in response to a selection of a different retail store, the processor requests a map of the different retail store from the server over the network, wherein the map of the different retail store shows locations of products associated with the offers currently selected by the user, the markers comprising a plurality of markers for the one offer where each of the plurality of markers is for a different product.

11. The mobile device of claim 8 wherein each marker is selectable such that when a marker is selected, details of an offer associated with the selected marker are displayed.

12. The mobile device of claim 8 wherein requesting a map from a server over a network comprises identifying a retail store that the mobile device is currently positioned within and requesting a map of the identified retail store.

13. The mobile device of claim 12 wherein requesting a map from a server over a network further comprises requesting a list of products associated with each offer currently selected by the user from a first server and providing the list of products with the request for the map.

14. The mobile device of claim 8 wherein the second user interface further comprises a count of the number of makers displayed on the map.

15. A method comprising:
displaying a user interface showing a map with a plurality of markers, each marker representing a different product associated with a single offer; and
receiving a selection of one of the markers and in response altering the user interface to show details of the single offer.

16. The method of claim 15 wherein displaying the user interface further comprises displaying markers for products associated with a plurality of offers.

17. The method of claim 16 wherein the plurality of offers comprise a limited number of offers selected by a user.

18. The method of claim 15 wherein the map comprises a map of a retail store that a user is located in.

19. The method of claim 15 wherein displaying the user interface comprises displaying a number indicating how many products associated with offers selected by the user are for sale in a retail store associated with the map.

20. The method of claim 15 further comprising displaying a user interface allowing a user to select an additional offer, receiving an indication that a map control has been selected and displaying a user interface showing the map with markers for products associated with the additional offer.
